(19) United States
(12) Patent Application Publication
(10) Pub. No.: US 2012/0270440 A1
(43) Pub. Date: Oct. 25, 2012

(54) COAXIAL CABLE CONNECTOR HAVING SLOTTED POST MEMBER

(75) Inventor: Souheil Zraik, Liverpool, NY (US)

(73) Assignee: JOHN MEZZALINGUA ASSOCIATES, INC., East Syracuse, NY (US)

(21) Appl. No.: 13/092,219

(22) Filed: Apr. 22, 2011

(51) Int. Cl. H01R 9/05; H01R 43/16

(52) U.S. Cl. 439/583; 29/874

(57) ABSTRACT

A coaxial cable connector includes a connector body and a post member disposed within the connector body. A coupling nut is threadingly attached to the post member wherein a flanged portion of the post member provides an axial biasing force with regard to an attached interface port. In one version, the flanged portion is slotted.

### FIELD OF THE INVENTION

The present application generally relates to the field of coaxial cable connectors and more specifically to a coaxial cable connector that provides secure attachment with an external interface port while preventing premature loosening of same.

### BACKGROUND OF THE INVENTION

Coaxial cable connectors are very well known in the field of communications, such as broadband communications, among other applications. A typical coaxial cable connector, such as an F-type connector, retains a coaxial cable end within a connector body. The connector further includes a rotatable threaded coupling nut that permits attachment of the connector to an appliance such as a television, computer or other device through an external interface port. A center conductor of the coaxial cable extends from the mating end of the connector and is retained within the complementary threaded port of the appliance. Reliable securement enables both electrical and mechanical interconnection to be made between the cable/connector and the device.

One pervasive problem relating to the engagement of the above types of coaxial cable connectors with an external appliance port is that the coupling nut associated with the connector can loosen over time due to several factors including a lack of adequate initial tightening of the nut, (i.e., improper number of turns), intentional or unintentional movement of the appliance, or other reasons.

Another general problem in the field relates to maintaining proper electrical continuity when the external appliance port is tightened onto the coaxial cable connector. Improper continuity can result in poor performance in which lack of shielding can lead to noise or other undesired electrical interference.

### SUMMARY OF THE INVENTION

According to one aspect, a connector for a coaxial cable includes a connector body, a post member, and a coupling nut. The connector body has a first end, an opposing second end, and defines a central passageway extending therethrough along an axis. The post member has a first end and a second end. The post member second end is disposed within the connector body and the post member first end includes a flanged portion. At least a portion of the flanged portion is configured to provide a biasing force along the axis. The coupling nut is rotatably attached to the first end of the post member.

In one version, the flanged portion of the post member includes an arcuate slot wherein at least the flanged portion is made from a spring material, such as steel or brass. In one version, the formed slot is helical. According to another version, the slot is spiral. In yet another version, the slot is an angled cut. In at least one of the above versions, the radial face of the flanged portion of the post member is also angled. The creation of the formed slot creates an axial bias that permits the post member to be compressively engaged by an interface port and permits electrical continuity to be repeatably maintained without requiring complete compressive attachment.

According to another aspect a coaxial cable connector includes a connector body having a hollow interior along an axis, and a post member having a first end and a second end. The first end includes a flanged portion that is axially and elastically compressible, and the second end is disposed within the connector body and axially secured thereto. The coaxial cable connector further includes a coupling nut rotatably secured and in overlaying relation to the first end of the post member.

According to yet another aspect, there is described a method of manufacturing a coaxial cable connector that permits electrical continuity between an interface port and the connector to be maintained during the entirety of an attachment procedure with the port. The method includes the steps of providing a connector body, rotatably attaching a nut in relation to one end of the connector body, and providing a post member within the connector body. The post member has a first end positioned within the nut and a second end extending into the interior of the connector body and axially secured therewith. The first end has a flanged portion, and the method further includes the step of forming a slot in the flanged portion. The flanged portion is made from a spring material, and the flanged portion has an angled face. The angled face is biased into a first position, wherein an interface port can be attached to the coaxial cable connector through threading engagement between the port and the coupling nut, causing the angled face and the slot of the flanged portion to be compressed to a second position and in which the biasing force of the flanged portion maintains electrical continuity between the post member and the port even when the nut is loosened from a fully tightened condition.

One advantage provided by the herein described coaxial cable connector is simpler assembly for use with fewer components than other known connectors, thereby also reducing cost.

Another advantage is that the herein described coaxial cable connector is versatility and improved reliability, as compared with prior art connectors.

These and other features and advantages will become readily apparent from the following Detailed Description, which should be read in conjunction with the accompanying drawings.

### BRIEF DESCRIPTION OF THE DRAWINGS

FIG. 1 is a perspective view of a coaxial cable connector assembly, partially broken away in section, which is made in accordance with a first embodiment of the present invention;

FIG. 2 is an exploded perspective view, portions thereof partially broken away in section, of the coaxial cable connector assembly of FIG. 1;

FIG. 3 is a sectioned elevational view of the coaxial cable connector assembly of FIGS. 1 and 2, in a first position;

FIG. 4 is the cross-sectional elevational view of the coaxial cable connector assembly of FIG. 3;

FIG. 5 is the cross-sectioned elevational view of the coaxial cable connector assembly of FIGS. 1-2, shown in a second position;

FIG. 6 is an exploded perspective view of a coaxial cable connector assembly in accordance with another exemplary embodiment;

FIG. 7 is a sectioned, perspective assembly view of the coaxial cable connector assembly of FIG. 6; and

FIG. 8 is a sectioned, elevational view of the coaxial cable connector assembly of FIG. 6, in a first position in relation to an attached interface port.

### DETAILED DESCRIPTION OF THE INVENTION

The following description relates to certain exemplary embodiments of a coaxial cable connector or connector assembly, the connector including means for providing a biasing force onto an external port attached to the connector upon application of a force from a coupling nut. The connector described herein is an F-type compression coaxial connector, though it will be readily apparent that other coaxial cable connectors such as, for example, RCA-type, BNC and other suitable types of connectors that can be attached releasably to an external interface port can also be suitably used. In addition, certain terms such as “distal”, “proximal”, “inner”, “outer”, “above”, “below” and the like are used throughout the course of discussion in order to provide a suitable frame of reference with regard to the accompanying drawings. These terms should not be regarded as overlimiting, however, except where so specifically indicated herein.

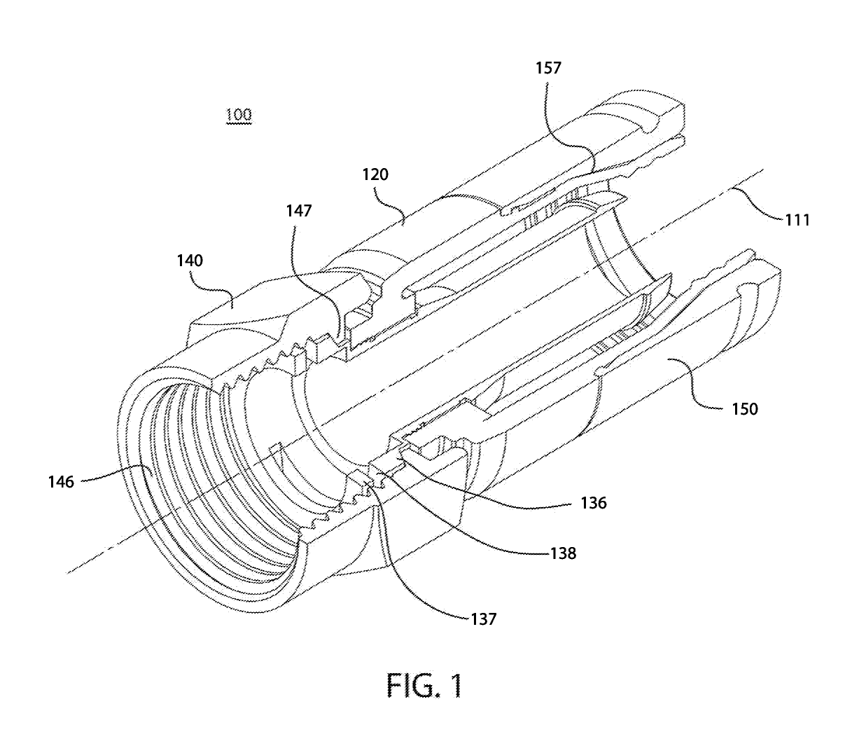

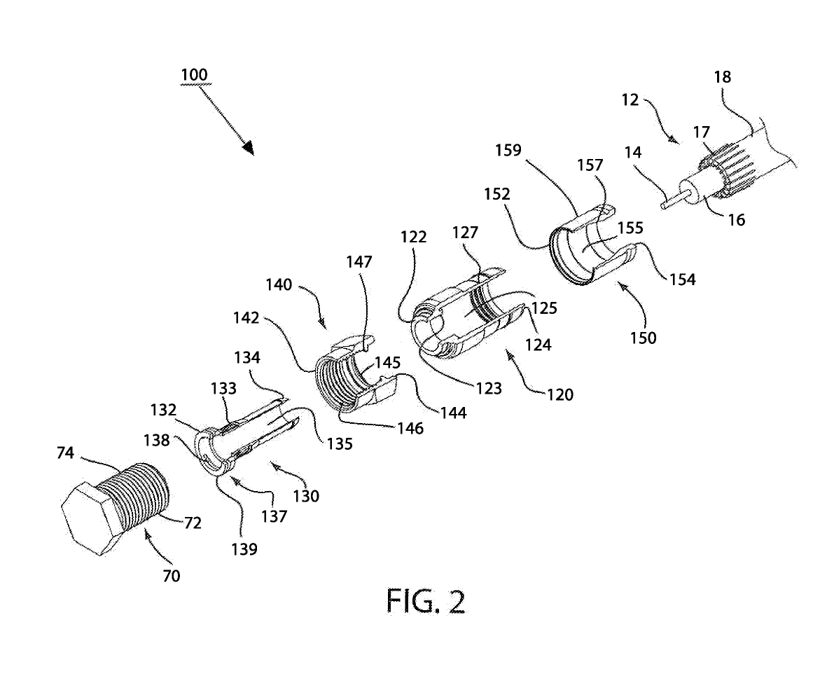

Referring to FIGS. 1 and 2, there is shown a connector assembly 100 in accordance with a first embodiment. The connector assembly 100 is manufactured from a plurality of components including a connector body 120, an inner post member 130, a coupling nut 140 and a compression member or sleeve 150.

The connector body 120 is defined by a substantially hollow cylindrical section further defined by a first end 122 and an opposing second end 124, wherein the ends are connected by a central passageway 125 extending therethrough. The center passageway 125 is defined by adjacent bores having different diameters; namely, a first interior diameter adjacent the first end 122, which is necked, and a second larger interior diameter adjacent the second end 124. The connector body 120 further includes a post securing portion 123 adjacent the first end 122, as well as a deformable axial portion 127 adjacent to the second end 124. The deformable axial portion 127 is made from an elastomeric material, which is deformable under sufficient applied forces. The remainder of the connector body 120 can be made from any suitable material, including metal and/or plastic.

As shown in FIGS. 1 and 2, the inner post member 130 is a hollow, substantially tubular section having a first end 132 with a tapering cross section that is sized to be fitted into the first end 122 of the connector body 120. The inner post member 130 further includes at least one exterior surface feature 133 that enables securement to the post securing portion 123 of the connector body 120, permitting the post to be axially as well as rotationally disposed within the connector assembly 100. The first end 132 of the inner post member 130 includes an annular flanged portion 137 that includes a center opening as well as a radial face 139. The first and second ends 132, 134 are interconnected by a center passageway 135 that extends entirely through the inner post member 130. The flanged portion 137 further includes an arcuate slot 138 angled approximately five degrees relative to the end plane of the post member 130 (the latter of which is substantially perpendicular to the longitudinal or primary axis of the inner post member 130 and connector assembly 100). This slot 138 can be made by means of milling, grinding, cutting, or other suitable process. The flanged portion 137 of the post member 130, at a minimum according to this embodiment, is made from a material providing elastic properties, such as steel or brass for example. The radial face 139 of the flanged portion 137 is formed at an angle substantially parallel to the angle of the slot 138, which according to this exemplary embodiment is approximately five (5) degrees relative to the radial end plane (which, as noted above, is substantially perpendicular to the longitudinal or primary axis 111 of the inner post member 130 and connector assembly 100).

Still referring to FIGS. 1 and 2, the coupling nut 140 is also defined by a first end 142 and an opposing second end 144 that is interconnected by a center passageway or bore 145. At least an axial interior portion of the coupling nut 140 is threaded. For purposes of the herein described embodiment, the entire axial length of the nut 140 or a selected portion thereof can include threads 146. The coupling nut 140 further includes a proximal end flange 147 adjacent the second end 144. The coupling nut 140 is secured according to this embodiment to the flanged portion 137 of the inner post member 130 for free rotation and is movable axially between first and second positions. When rotated, the proximal end flange 147 of the coupling nut 140 is caused to engage against a corresponding end flange 136 of the inner post 130. Alternatively, the coupling nut 140 can be axially secured to either the connector body 120 and/or the post member 130 while still being freely rotatable.

The compression member 150 according to this exemplary embodiment is defined as a substantially cylindrical section, such as a sleeve, which is further defined by a first end 152 and an opposing second end 154, the two ends being interconnected by a central passageway 155. The central passageway 155 includes a conical surface 157 adjacent the first end 152 that generally tapers from a larger first diameter adjacent the first end to a smaller second diameter extending to the second end 154. The compression member 150 can be made from steel, plastic or other suitable material. In one version, the exterior surface 159 of this compression member 150 is knurled for ease of use or can alternatively include an elastomeric covering.

A prepared end of a coaxial cable 12, shown only in FIG. 2, is secured to the herein described coaxial cable connector 100. As shown only in FIG. 2, the coaxial cable 12 is defined by a center conductor 14, an intermediate dielectric layer 16, a shielding layer 17, which can include braiding and an outer covering or sleeve 18. In preparing the cable end, an axial portion of the outer covering 18 is stripped away as is a portion of the dielectric layer 17, exposing an axial portion of the dielectric layer 16 and center conductor 14. A portion of the dielectric layer 17 is also stripped or cored away, leaving an exposed axial section of the center conductor 14.

For purposes of the herein described connector 100 and still referring to FIG. 2, the prepared cable end is inserted into the second end 124 of the connector body 120 and engaged between the intermediate dielectric layer 16 and the grounding shield layer 17 by means of the extending barbed second end 134 of the inner post member 130. The grounding shield layer 17 and the outer sleeve 18 of the cable 12 are retained in an annular space or pocket formed between the connector body 120 and the inner post member 130, while the center conductor 14 and intermediate dielectric portion 16 of the prepared coaxial cable end pass through the center passageway 135 of the post member 130. The extending center conductor 14 is advanced through the center opening of the first end 132 of the post member 130 into the center bore 145 of the coupling nut 140. The compression member 150 is then axially advanced over the exterior of the connector body 120 using a compression tool (not shown) or other suitable means, wherein the ramped interior surface 157 engages the deformable axial portion 127 of the connector body 120, causing this portion to radially deform inwardly and securing the coaxial cable end 12 into position.

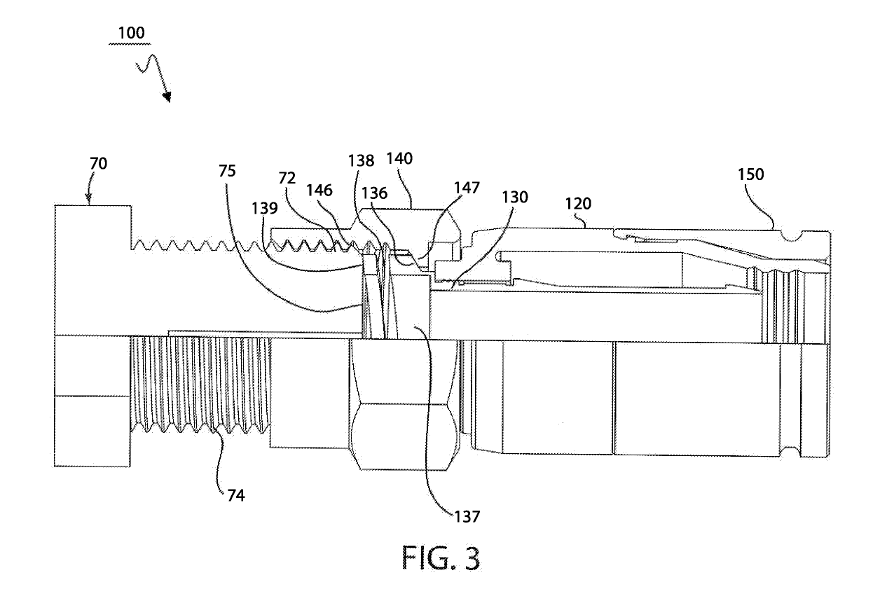

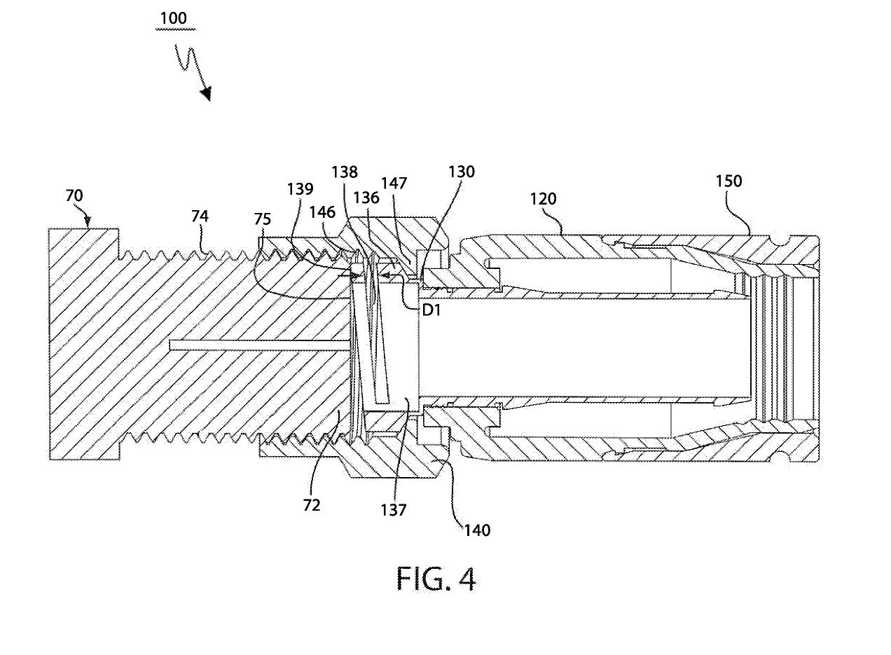

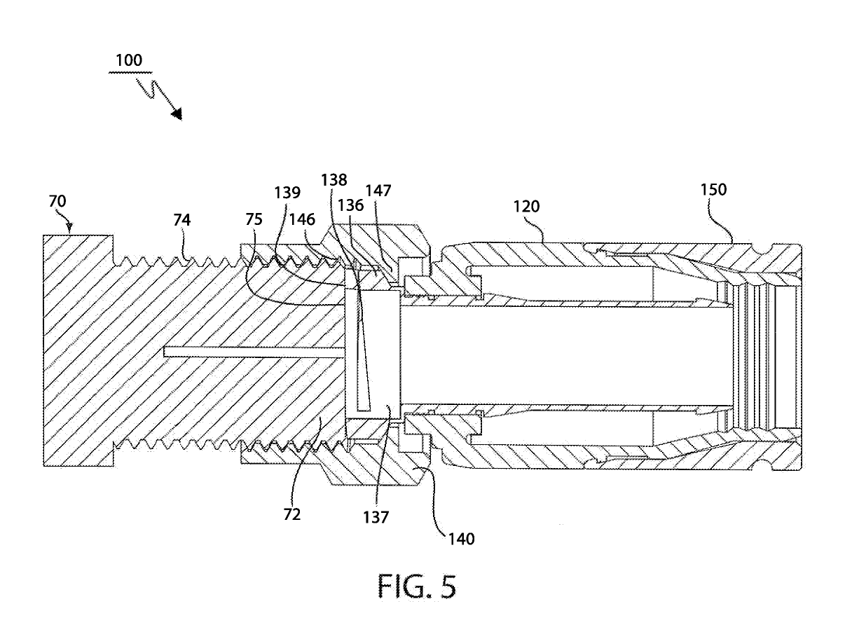

As shown in FIGS. 2-5, the coaxial cable connector 100, including the secured coaxial cable end 12 (not shown in FIGS. 3-5 for purposes of clarity) can receive an external interface port 70, the port including a distal end 72 that further includes a set of external threads 74. The threads 74 of the interface port 70 include a pitch and height that corresponds with or complement those of the internal threads 146 of the coupling nut 140. It will be understood that though the herein described external port 70 is threaded, the above concepts will also operate similarly for RCA-type connectors, such as those described in U.S. Pat. No. 7,462,068, the entire contents of which are herein incorporated by reference.

As the interface port 70 is tightened onto the coaxial cable connector 100 by threading engagement of the coupling nut 140 as shown in FIGS. 3-5, a radial face 75 at the distal end 72 of the interface port 70 engages directly with the angled face 139 of the inner post member 130. This engagement creates a compressive force against the flanged first end 132 of the inner post member 130 as the coupling nut 140 continues to be tightened and causes compression thereof over a working distance D1 as the slot 137 is closed. In the event loosening of the coupling nut 140 takes place, the radial face 75 is maintained in contact with the radial face 139 of the inner post member 130 based on the biasing force applied by the angled slot 138. As a result, interconnection and electrical continuity are each maintained.

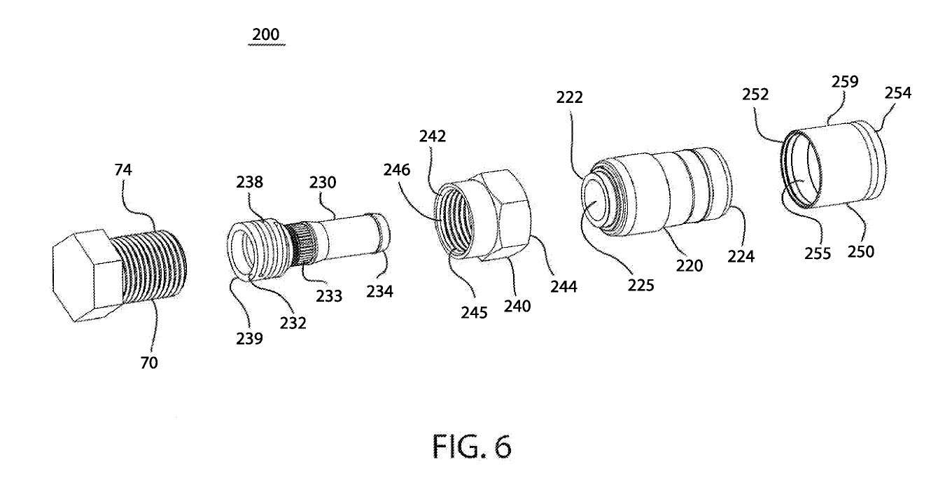

It will be readily apparent that additional or alternative versions of an inner post that is suitably and flexibly compressible in relation to an attached interface port are possible. For example and referring to FIGS. 6-8, wherein like numerals indicate like elements, there is illustrated a coaxial connector assembly 200, the assembly also having a plurality of components. The connector assembly 200, like the preceding version, includes a connector body 220, an inner post member 230, a coupling nut 240 and a compression member or sleeve 250.

As in the preceding embodiment, the connector body 220 is defined by a substantially hollow cylindrical section further defined by a first end 222 and an opposing second end 224, wherein the ends are connected by a central passageway 225 extending therethrough. The center passageway 225 is defined by adjacent bores having different diameters; namely, a first interior diameter adjacent the first end 222 which is necked, and a second larger interior diameter adjacent the second end 224. The connector body 220 further includes a post securing portion 223 adjacent the first end 222, as well as a deformable axial portion 227 adjacent to the second end 224. The deformable axial portion 227 is made from an elastomeric material, which is deformable under sufficient applied forces. As in the preceding, the remainder of the connector body 220 can be made from any suitable material, including metal and/or plastic.

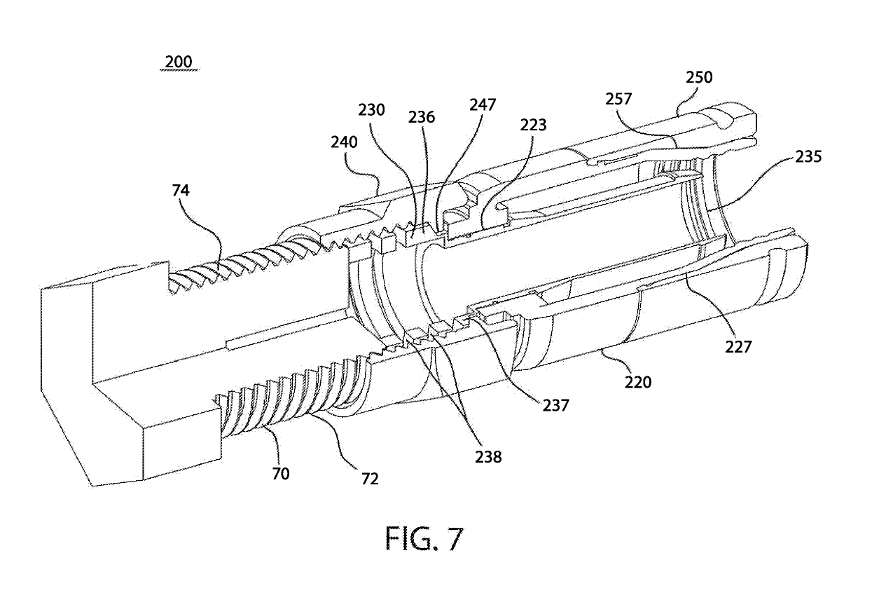

As shown in FIGS. 6 and 7 and also like the preceding, the inner post member 230 is a hollow, substantially tubular section having a first end 232 having a tapering cross section that is sized to be fitted into the first end 222 of the connector body 220. The inner post member 230 further includes at least one exterior surface feature 233 that enables securement of the post member to the post securing portion 223 of the connector body 220, thereby permitting the post member to be axially as well as rotationally secured to the connector assembly 200. The first end 232 of the inner post member 230 includes an annular flanged portion 237 that includes a center opening as well as a radial face 239. The first and second ends 232, 234 are interconnected by a center passageway 235 that extends entirely through the post member 230. Unlike the preceding embodiment, the flanged portion 237 further includes a helically wound slot 238. This helical slot 238 can be made by means of milling, grinding, cutting, or other suitable process wherein the angle of the helical cut made is substantially between about 3 and 5 degrees in relation to the radial end plane of the inner post member (the latter of which is substantially perpendicular to the primary or longitudinal axis of the inner post member 230 and connector assembly 200). The flanged portion 237 of the inner post member 230, at a minimum according to this embodiment, is made from a material providing elastic properties, such as steel or brass, for example. Unlike the preceding embodiment, however, the radial face 239 of the flanged portion 237 is not angled in relation to the angle of the defined helical slot 238 but rather the radial face 239 is substantially perpendicular to the longitudinal or primary axis 211 of the inner post member 230 and connector assembly 200).

Still referring to FIGS. 6 and 7 and like the preceding, the coupling nut 240 is also defined by a first end 242 and an opposing second end 244 that is interconnected by a center passageway or bore 245. At least an axial interior portion of the coupling nut 240 is threaded. For purposes of the herein described embodiment, the entire axial length of the nut 240 or a selected portion thereof can include threads 246. The coupling nut 240 further includes a rear end flange 247 adjacent the second end 244. The coupling nut 240 is secured according to this embodiment to the inner post member 230 for free rotation and is movable axially between first and second positions in which the end flange 247 engages an end flange 236 of the inner post member 230. Alternatively, the coupling nut 240 can be axially secured to either the connector body 220 and/or the post member 230 while still being freely rotatable.

The compression member 250 according to this exemplary embodiment is defined as a substantially cylindrical section, such as a sleeve, which is further defined by a first end 252 and an opposing second end 254, the two ends being interconnected by a central passageway 255. The central passageway 255 includes a conical surface 257 adjacent the first end 252 that generally tapers from a larger first diameter adjacent the first end to a smaller second diameter extending to the second end 254. The compression member 250 can be made from steel, plastic or other suitable material. In one version, the exterior surface 259 of this compression member 250 is knurled for ease of use or can alternatively include an elastomeric covering.

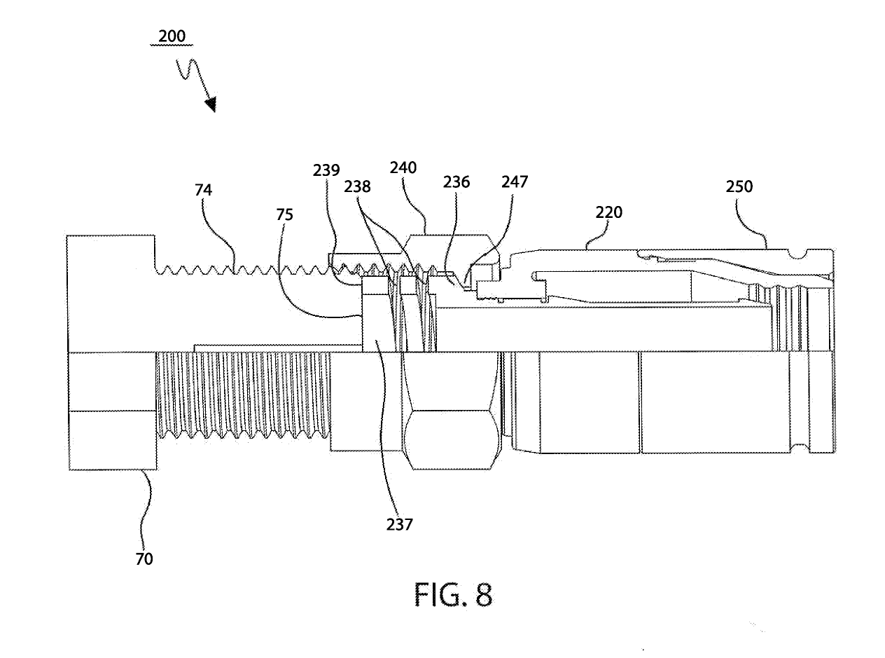

In operation, a coaxial cable (not shown) is prepared and attached to the compression member side of the connector assembly 200, in the manner previously described. With reference to FIG. 8, the coupling nut 240 is attached such that the nut can freely rotate wherein the flanged portion 237 of the inner post member 230 is mounted within the interior of the coupling nut 240 such that the end flange 247 of the nut engages with a corresponding end flange 236 of the inner post member 230. As the interface port 70 is engaged with the connector assembly 200, the radial face 75 of the interface port 70 is caused to engage with the radial face 239 of the inner post member 230, causing the flanged portion 237, including the helical slot 238 to close as the coupling nut 240 is tightened. As in the preceding, loosening of the coupling nut 240 following attachment of the interface port 70 still provides substantial contact between the radial end faces 239, 75 of the inner post member 230 and the interface port 70, respectively, based on the bias provided by the helical slot 238.

Though the invention has been described with regard to certain embodiments, it will be readily apparent that other modifications and variations are possible within the intended scope of the claims as follows.

What is claimed is:

1. A coaxial cable connector comprising:
a connector body having a first end, an opposing second end, and defining a central passageway extending therethrough along an axis;
a post member having a first end and a second end, the post member second end being disposed within the connector body and the post member first end including a flanged portion, at least a portion of the flanged portion configured to provide a biasing force along the axis; and
a coupling nut rotatably attached to the first end of the post member.

2. A connector as recited in claim 1, wherein the flanged portion of the post member includes a helical slot to provide the axial biasing force.

3. A connector as recited in claim 1, wherein the flanged portion of the post member includes an angled slot to provide the axial biasing force.

4. A connector as recited in claim 3, wherein a radial face of the flanged portion of the post member is angled with respect to a plane perpendicular to the axis.

5. A connector as recited in claim 4, wherein the radial face is parallel to the angle of the slot.

6. A connector as recited in claim 1, wherein each of the post member and the port are made from electrically conductive materials.

7. A connector as recited in claim 1, wherein the connector is an F-type connector.

8. A coaxial cable connector, the connector comprising:
a connector body having a hollow interior along an axis;
a post member having a first end and a second end, the first end including a flanged portion being axially and elastically compressible, the second end being disposed within the connector body and axially secured thereto; and
a coupling nut rotatably secured and in overlaying relation to the first end of the post member.

9. A connector as recited in claim 8, wherein the flanged portion of the post member includes at least one angled slot.

10. A connector as recited in claim 8, wherein the connector is an F-type connector.

11. A connector as recited in claim 8, wherein the flanged portion of the post member includes a radial face, the face being angled parallel to the angle of the formed slot.

12. A connector as recited in claim 8, wherein the slot is helical.

13. A connector as recited in claim 8, wherein the slot is spiral.

14. A method of manufacturing a coaxial cable connector that permits electrical continuity between an interface port and the connector to be maintained during the entirety of an attachment procedure with the interface port, the method comprising the steps of:
providing a hollow connector body;
rotatably attaching a nut in relation to one end of the connector body;
providing a post member within the connector body, the post member having a first end positioned within the nut and a second end extending into the interior of the connector body and axially secured therewith, the first end of the post member having a flanged portion; and
forming a slot in the flanged portion of the post member, the flanged portion being made from a spring material, the flanged portion having an angled face wherein the angled face is axially biased into a first position;
wherein an interface port can be attached to the connector through threading engagement between the port and the nut causing the angled face and the slot of the flanged portion to be compressed to a second position and in which the axial biasing force of the flanged portion maintains electrical continuity between the post member and the interface port even when the nut is loosened from a fully tightened condition.
